(19) United States
(12) Patent Application Publication
(10) Pub. No.: US 2007/0241062 A9
(43) Pub. Date: Oct. 18, 2007

(54) Synergistic composition and method for odor control

(76) Inventors: Gregory D. Simpson, Seabrook, TX (US); Glenn W. Holden, Spring, TX (US)

Correspondence Address: LOWRIE, LANDO & ANASTASI, LLP;U0105, 1 MAIN ST., SUITE 1100, CAMBRIDGE, MA, 02142, US

(21) Appl. No.: 11/177,006

(22) Filed: Jul. 8, 2005

Related U.S. Application Data
(60) Provisional application No. 60/586,349, filed on Jul. 8, 2004.

(51) Int. Cl. C02F 1/58

(52) U.S. Cl. 210/749; 210/916

(57) ABSTRACT

A synergistic composition and method is provided for controlling odor from waste products. The composition comprises a combination of magnesium hydroxide and a sulfide-consuming compound. The method includes adding a sufficient amount of the composition to a waste stream to provide sufficient sulfide-consuming compound to effect immediate removal of sulfide. The composition incorporates a pH elevating and buffering compound, which both increases and buffers the pH. The increased pH serves to reduce both the volatile sulfide species and the volatile fatty acid (VFAs) species. The elevated pH also promotes the growth of naturally occurring bacteria which metabolize the sulfide to an innocuous form. Finally, addition of the composition drives the pH into a range where the growth of sulfide producing bacteria is inhibited. The mixture has surprisingly been found to be synergistic with respect to both control of chemical species that produce odors and corrosion of metals commonly found in sludge dewatering equipment.

### RELATED APPLICATIONS

This application refers to Provisional Application Ser. No. 60/586,349 filed Jul. 8, 2004.

### FIELD OF THE INVENTION

The present invention relates to a method and composition for inhibiting the production and release of gaseous compounds, which result in odors, from organic waste produced by metabolic processes, including human and animal waste, as well as industrial wastes, effluents, sewage, and the like.

### BACKGROUND OF THE INVENTION

The biogenic production of volatile compounds which cause objectionable odors is one of the problems associated with the collection and treatment of various waste materials. Domestic sewage is the largest source of such odorous compounds. Because of the magnitude of domestic sewage that is collected and treated and the associated odorous compounds, the present invention is particularly directed, but not limited to the control of sulfidic compounds in municipal or industrial waste. As used herein, the term “sulfidic compounds” also includes hydrogen sulfide (H₂S), mercaptans (RSH), and other related odoriferous sulfidic compounds.

The mixed biological population common to municipal or industrial waste utilizes the compounds found in the waste as a source of nutrient. In this process, oxygen is the preferred terminal electron acceptor, and the nutrient, commonly an organic compound, is oxidized. In highly nutrient loaded systems such as municipal sewage, bacterial action can result in a rapid consumption of oxygen in the water. In the absence of oxygen, bacteria require an alternate terminal electron acceptor.

In general, bacteria will utilize the terminal electron acceptor that provides them with the greatest amount of energy. Thus, there is a preferred selection order of a terminal electron acceptor by bacteria. This order is shown below:
O₂>NO₃⁻>Fe⁺²>SO₄⁻²>C₃⁻²

As nitrate is not typically found in natural waters, the sulfate ion (SO₄⁻²) is generally the preferred alternate. In the absence of oxygen, unless nitrate is added supplementally, those bacteria which can utilize sulfate as a terminal electron acceptor in their respiration process will predominate. The best known and most highly characterized bacteria of this type is Desulfovibrio desulfuricans. These bacteria are most commonly referred to as sulfate-reducing bacteria, SRB. SRB are known to metabolize sulfate ion with organic matter to form H₂S as shown in the following equation.
SO₄⁻²+organic matter+SRB—H₂S+CO₂+H₂O

H₂S, responsible for the characteristic odor from rotten eggs, is toxic in low concentrations. Citizen complaints are often the driving force behind efforts to control odor. Such odors are generally regarded as a public nuisance and a health hazard.

H₂S is also corrosive towards steel and concrete.

Although H₂S is a gas, H₂S in water can dissociate with increasing pH as shown in the following equations. Thus at a given pH, the relative amount of dissolved H₂S species can be predicted. The sulfide ion, S⁻², and bisulfide ion, HS—, being ionic, remain in the aqueous phase.
H₂S+OH⁻→HS⁻+H₂O
HS−+OH⁻→S⁻²+H₂O
(H₂S— gas phase & aqueous phase, HS⁻ & S⁻² aqueous phase)

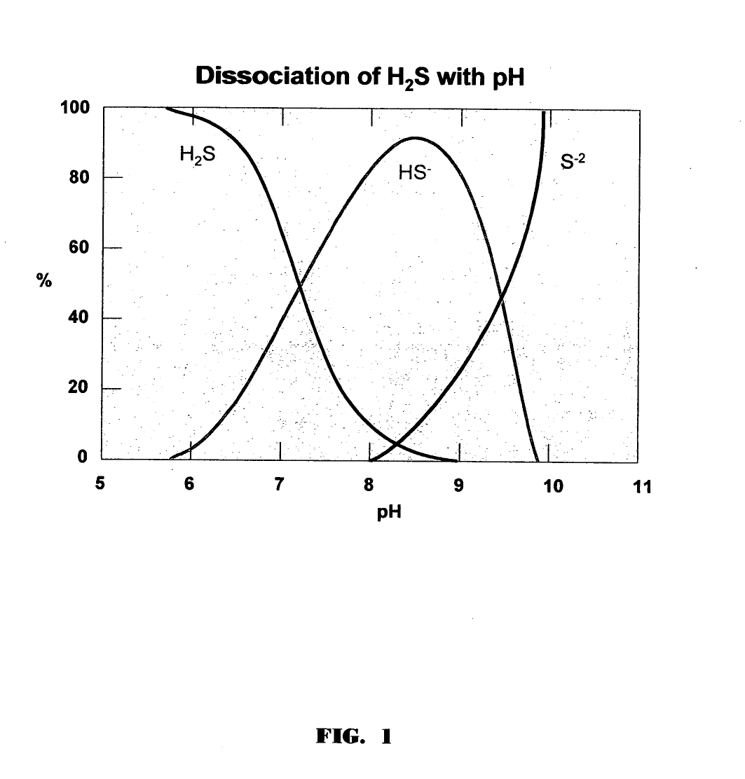

FIG. 1 shows the pH relationship between these species, the evolution of the gas from aqueous solution being a function of pH. At the pH typically found in sewer systems, a significant percent of the H₂S formed evolves from solution. The gas can redissolve on the crown of the sewer line, and the presence of Thiobacillus bacteria and others, metabolize the H₂S, producing sulfuric acid, H₂SO₄. This can and has resulted in sewer line collapse and results in a significant cost in terms of their repair and replacement.

Various compounds, including hypochlorite (sodium or calcium), potassium permanganate, nitrate (calcium, sodium and ferric), ferrous and ferric salts, hydrogen peroxide, chlorine, chlorine dioxide, sodium chlorite, and more recently, magnesium oxide or magnesium hydroxide have been used for the control of odor in wastes, and sewage waste in particular.

Sodium chlorite has been used alone for odor control. Several references to such use follows:
“Control of Odors from Sewage Sludge,” Gas, Wasser, Abwasser, Vol. 65, pp. 410-413 (1985) in Chemical Abstracts 104:10062 (German);
“Polyelectrolyte Conditioning of Sheffield Sewage Sludge,” Water Science Technology, Vol. 16, pp. 473-486 (1984) in Chemical Abstracts 102:100249;
“Slime and Odor Elimination in Process Water of the Paper Industry,” Papier, Vol. 29, pp. 43-51 (1975) in Chemical Abstracts 85:82749 (German); and
“Deodorization of Sludge for Dewatering by Controlled Adding Chlorite,” Japanese Patent Publ. No. 06320195 (1994).

It is also known that nitrates added to sewage effect reduction in BOD and even suppress the formation of hydrogen sulfide gas via bacterial action.
U.S. Pat. No. 3,300,404 for example, cites the use of about 500 ppm of nitrate to prevent odor emanation from a lagoon.
U.S. Pat. No. 4,911,843 cites the use of cite the use of nitrate to remove existing sulfide. A dosage of 2.4 parts nitrate-oxygen per part of existing dissolved H₂S is required.
U.S. Pat. Nos. RE36,651 and RE37,181E cite the use of nitrate to remove existing sulfide. A dosage of 2.4 parts nitrate-oxygen per part of existing dissolved H₂S is required.

Even nitrite has been used to control sulfate reducing bacteria and associated odors:
U.S. Pat. No. 4,681,687 cites the use of sodium nitrite to control SRB and H₂S in flue gas desulfurization sludge.

In addition, the use of some sulfide reactive chemicals in combination with nitrates is known:
For example, U.S. Pat. No. 3,966,450 cites the use of 5-500 mg/L of hydrogen peroxide and the addition of nitric acid to maintain a pH of 3.5-5.5 to enhance the nutrient value of the waste.
U.S. Pat. No. 4,108,771 cites the use of chlorate and nitrate coupled with an iron salt in pH <5 to control odors in a waste stream.
U.S. Pat. No. 4,446,031 cites the use of an aqueous solution of ferric sulfate and ferric nitrate in a ratio of from 1:0.5 to 1:3 to control odors in rising sewer mains. Optionally the composition may contain nitric acid.
U.S. Pat. No. 5,114,587 cites the use of nitrate in conjunction with oxygen, air, or iron salt, the dosage controlled by ORP, to reduce the concentration of soluble organic matter.
U.S. Pat. No. 5,200,092 cites the use of about 0.5 to about 10 weight percent potassium permanganate with about 0.5 to about 42 weight percent sodium nitrate for odor control. Feedrate of the product is such that the permanganate:sulfide ratio is maintained in the range of from about 2:1 to about 6:1.
U.S. Pat. No. 5,405,531 cites the use of nitrite and nitrate and/or molybdate for removal of H₂S in an aqueous system.
U.S. Pat. No. 5,984,993 cites the use of a synergistic blend of 22.5 weight percent chlorite salt and 10 weight percent sodium nitrate for controlling odors.

A combination of nitrate and microorganisms is taught in the following patent:
U.S. Pat. No. 6,059,973 teaches an emulsion of nitrate and microorganisms of the Bacillus type for odor control in sewers.

Other compounds reactive with sulfide are known:
U.S. Pat. No. 3,959,130 cites the use of pH adjustment to a value over 7.0 and bringing the stream into contact with an ash product to control cyanide and hydrogen sulfide.
U.S. Pat. No. 4,501,668 cites the use of polycondensation products produced by the condensation of acrolein and formaldehyde to consume hydrogen sulfide in aqueous systems, such as waste water clarification plants.
U.S. Pat. No. 4,680,127, cites the use of glyoxal, or glyoxal in combination with formaldehyde or glutaraldehyde, to reduce or scavenge the hydrogen sulfide in aqueous or wet gaseous mediums.

The use of compounds to elevate pH to convert sulfide species to ionic species which remains in solution and minimizes H₂S gas evolution is taught in the following patents:
U.S. Pat. No. 3,959,130, describes the use of fly ash to elevate the pH of a waste stream containing cyanide and possibly H₂S to above 8.0.
U.S. Pat. No. 5,833,864, cites the use of magnesium oxide or magnesium hydroxide to elevate the pH to the range of 7.5-9.5, thus minimizing the amount of sulfide in the form of gaseous H₂S.

Some of the treatments using specific chemicals have advantages in certain applications. However, they also suffer from various drawbacks, some of which are listed below. The chemicals are separated by their rate of reaction with sulfide or H₂S.

TABLE 1
Limitations of Various Technologies

Reacts rapidly with H₂S or sulfide
Hypochlorite

Can degrade during storage.
Reacts with ammonia for additional consumption.
Generates chlorine odor with over-doses.
Has no long-term effect.
Corrosive to feed equipment

Potassium Permanganate

Powder is labor intensive to add.
Causes discoloration with over-doses.
Results in precipitation of manganese.

Iron Salts

Are ineffective for non-sulfide odors.
Cause build-up of solids.
Impure products can contain heavy metals.
Can be toxic to microorganisms.
Deplete dissolved oxygen and alkalinity.
Corrosive to feed equipment.

Chlorine Dioxide

Requires a generator, multiple precursors.
Generates chlorine-type odor with over-doses.
Is not long lasting.

Sodium Chlorite

Can be costly in high doses.
Is corrosive to both carbon steel and stainless
Use costs increase significantly when iron salts are used
as coagulant

Sodium Chlorite/Nitrate blends

Is corrosive to both carbon steel and stainless
Is expensive relative to other technologies.

Moderately fast catalyzed reaction with H₂S or sulfide
Hydrogen Peroxide

Slow reacting without catalyst
Requires catalysis for non-sulfide odors.
Causes foaming.
Is not long lasting.

Reacts very slowly or does not react directly with H₂S or sulfide
Nitrates

Have no immediate or short term effect.
Produce nitrogen by-products which can present treatment
problems.
Reacts indirectly by promoting thegrowth of sulfide-
oxidizing bacteria
Require the presence of nitrate-reducing, sulfide
oxidizing bacteria
Can cause foaming

Magnesium oxide, Magnesium hydroxide, Calcium oxide,
Calcium hydroxide

Sparingly soluble
Fed as a slurry
Can result in precipitation and plugging of pumps, lines
With high levels of H2S, will not alone provide
sufficient reduction of gaseous H2S

In the control of odors, there are three primary types of odor control chemistries that are required. These are listed in chronological order of appearance. The first type is for municipal sewer lines, or similar applications. In such applications, the biogenic generation of H₂S occurs in pipes with residence times on the order of hours or days, and thus any chemical added has a substantial amount of time to work. Those chemicals which act in a slow to moderate manner are acceptable in such applications.

The second type is for sludge dewatering, where the H₂S must be consumed immediately. Generally chemistries which are slow to react with H₂S are not acceptable in such applications.

The third type of odor control chemistry is for dewatered sludge, where the sludge may sit for days or weeks prior to being landfilled or moved. Chemistries that are very slow to react are acceptable in such applications.

There are additional factors which may impact the choice of odor control chemistries. One such factor is the impact such chemical has on corrosion of piping or equipment. Sometimes this factor is paramount in the selection of odor control chemistry, and some of these chemistries are significantly more corrosive than others.

One final factor which is just beginning to be recognized is the impact monovalent and polyvalent cations have on floc formation in sludge, and its ultimate impact on sludge dewatering. In fact, researchers have identified that there is an optimum ratio of monovalent to divalent cations in the formation and stability of floc formed, and ultimately in the dewaterability of the sludge formed. A dryer sludge cake translates directly to reduced shipping costs of the dewatered sludge.

In view of the disadvantages and additional factors cited above, there is a need in the art for a method and composition for abating odor in waste materials that is cost effective, has the capability of consuming aqueous sulfide or H₂S immediately, adjusts the pH into a range where the volatile form of sulfide species is very low, and provides long term control of biogenic sulfide production. Additionally the method and composition should be less corrosive and should have stable floc formation and as a result the sludge should dewater easily. Accordingly, it is an object of the present invention to address this need in the art. This and other objects of the present invention will become more apparent in light of the following summary and detailed description of the invention.

### SUMMARY OF THE INVENTION

This invention relates to a method and composition for the elimination or reduction of sulfidic odors in sewer systems, municipal waste treatment plants and in other industrial waste applications, sludge dewatering, and in the dewatered sludge. The composition comprises a synergistic combination of a rapid sulfide-consuming chemical and a chemical which both increases and buffers the pH, a chemical which acts as an organic biocide, and a chemical which provides long term biogenic prevention.

Existing sulfides are consumed immediately by the sulfide-consuming chemical. The pH-elevating compound adjusts the pH into a range of >7.5, where the form of volatile sulfide is minimized. In addition, adjustment of the pH into this range promotes growth of sulfide-consuming bacteria and inhibits the growth of sulfide-producing bacteria. The organic biocide also consumes H2S while at the same time targeting sulfide-producing bacteria to both prevent and minimize H2S. The chemical preventing long term biogenic H2S production acts as a terminal electron acceptor so that the bacteria metabolize the chemical rather than sulfate, thus preventing the formation of H2S. In addition, the chemical promotes the growth of competing bacteria which produce metabolites that are inhibitory to sulfide producing bacteria.

The sulfide consuming chemical is selected from the group comprising an iron salt, a hypochlorite, a permanganate, a persulfate, a perborate, a periodate, a percarbonate, a chlorite, a nitrite, a chlorate, a perchlorate and a peroxide. The pH elevating and buffering chemical is magnesium oxide, magnesium hydroxide, magnesium carbonate, or magnesium peroxide. The organic biocide is selected from the group comprising glutaraldehyde and tetrakis (hydroxymethyl) phosphonium sulphate (THPS). The chemical for long term prevention of biogenic sulfide is selected from the group comprising metal and alkali metal nitrates. The method according to the present invention comprises the step of contacting the waste products or their surrounding airspace with the composition.

Unexpected benefits are predicted to arise also from application of the composition. Application of chlorite has been found to enhance dewaterability of produced sludge in some applications. In addition, application of Mg(OH)2 alone has also been found to promote the dewaterability of sludge, although the mechanisms by which these two chemicals act are different. There is an expected synergy when both of these chemicals are applied simultaneously in that the dewaterability of sludge is enhanced over that which would be seen by application of each chemical separately.

Another unexpected benefit is that long term odor of dewatered sludge, which is troublesome in land application of such sludge, is predicted to be controlled much better by the composition than by each component of the composition when applied separately.

A third unexpected benefit is that the corrosivity of the preferred embodiment is significantly reduced.

A final unexpected benefit is that the level of pathogenic bacteria found in the dewatered sludge is significantly reduced over untreated sludge. This is very important in situations where the sludge is applied to land to act as a fertilizer.

### DETAILED DESCRIPTION OF THE INVENTION

The composition for controlling odor from waste products according to the present invention comprises a combination of a rapid-acting sulfide-consuming material and a longer acting material which elevates and buffers pH >7.5. At this pH range, the solubility of H2S in the aqueous phase is increased substantially, and the growth of sulfide-producing bacteria is inhibited, as shown in Table 2.

TABLE 2
Optimum pH Growth Range for SRB (from Yarnell)

| | | Optimum |
|---|---|---|
| Year | Source | pH range |
| 1993 | Bergey's Manual of Determinative Bacteriology | 6.6-7.5 |
| 1946 | Pomeroy and Bowlus | 7.5-8.0 |
| 1992 | Reis, et. al. | 6.7 |
| 1997 | Reichenbecher et. al. | 7.2 |
| 2000 | Yarnell | 6.0 |

Bergey's Manual of Determinative Bacteriology, 9^{th} ed., Williams and Williams, Md., 1994.
Pomeroy R., and Bowlus, F., “Progress Report on Sulfide Control Research,” orks Journal, 18, 597(1946).
Reis, M., Almeida, J., Lemos, P., and Carrondo, M., “Effect of Hydrogen Sulfide on Growth of Sulfate Reducing Bacteria,” Biotechnology and Bioengineering, 40, 593(1992).
Reichenbecher, W., and Schink, B., “Desulfovibrio inopinatus, sp. nov., a New Sulfate-Reducing Bacterium that Degrades Hydroxyhydroquionone (1,2,4-trihydroxybenzene),” Arch Microbi9ol, 168, 338(1997).,
Yarnell, E., “Effect of Mg(OH)2 addition on Odor and Corrosion Associated with H2S and the Effect on Wastewater Treatment Processes,” MS Thesis, Bucknell University, Apr. 11, 2000.

The rapid-acting sulfide consuming material is selected from the group which includes an iron salt, or a hypochlorite, a permanganate, a persulfate, a perborate, a periodate, a percarbonate, a chlorite, a nitrite, a chlorate, a perchlorate and a peroxide of ammonium, metal or alkali metal. The longer acting chemical which raises and buffers the pH is magnesium oxide or magnesium hydroxide. The pH is adjusted and buffered into a range where the concentration of the volatile sulfide species is minimized, and where the formation of biogenic sulfide is minimized because the pH is adjusted to a range where growth of sulfide-producing bacteria is inhibited. The organic biocide is chosen from the group comprising glutaraldehyde and tetrakis (hydroxymethyl) phosphonium sulphate (THPS). The biocide aids in sulfide consumption and in particular targets sulfide producing organisms, inactivating them and preventing their production of volatile sulfide over a longer time period. The chemical used for prevention of long term biogenic sulfide production is selected from the group comprising metal or alkali metal nitrates. The nitrate acts as a terminal electron acceptor and is preferentially metabolized by bacteria over sulfate, and as a result, biogenic sulfide production is eliminated or greatly reduced. As used herein, the term “controlling odor” means reducing and/or eliminating odor that is offensive to humans. Such odors are usually caused by volatile sulfides and other volatile odorous substances.

The waste products treatable with the present invention include, but are not limited to organic waste produced by metabolic processes, including human and animal waste, as well as industrial wastes, effluents, sewage, and the like. The preferred aqueous composition includes sodium chlorite at a weight percent of 0.01-31%, magnesium hydroxide which may range in concentration from 0.01-65% weight percent, THPS, which may range in concentration from 0.01-10%, sodium nitrate which may range in concentration from 0.1-40% by weight and water at 4%-99.98 wt %. The preferred dry composition includes sodium chlorite at concentrations of 0.01-75% and magnesium hydroxide at 25-99.99%.

The aqueous solution or the dry composition according to the invention can be employed to destroy and prevent the malodorous characteristics of odor causing compounds such as sulfides or volatile fatty acids found in sewage and other waste products. The solution can be pumped into the material to be treated (liquid, sludge, or solid) or sprayed onto the surface or into the airspace surrounding the material. The dry material can be mixed into a slurry or solution at the point of application and applied in a similar manner.

This method and composition involve three primary application areas. These include treatment at fairly low levels into municipal sewer lines and the like, sludge dewatering applications, and sludge dewatering applications where the sludge is to be held for several days. Each area will be discussed in some detail.

Municipal Sewer Lines: Sodium chlorite reacts very slowly, if at all, with the vast majority of compounds found in sewage at the pHs normally encountered in sewage. It will, however, react rapidly with sulfidic compounds. Thus, the vast majority of the chlorite added to the sewage will consume sulfidic compounds, which generally allows low concentrations to be used. The sodium chlorite provides rapid control of low levels of sulfides commonly found at upstream points early in the sewer line distribution system. The treatment concentration is directly dependent upon the amount of odor causing compounds with chlorite demand that are present in the waste.

The magnesium hydroxide buffers pH to a range sufficiently high so that sulfate reducing bacteria do not thrive, and thus are prevented from producing H₂S. The arrest of H₂S production using magnesium hydroxide alone is not immediate, and in some situations, if the sulfide is sufficiently high, has been shown to be ineffective at controlling sulfide odors. The concentration of magnesium hydroxide present in the treatment solution may vary depending upon the amount of residual control of malodorous compounds that is required. Magnesium hydroxide is less costly than chlorite and thus lowers the cost per pound of the treatment solution.

The preferred embodiment of such a composition for treatment of municipal sewer lines would include a 45-55 wt % Mg(OH)2/0.1-2 wt % NaClO2 blend. The preferred application rate would be to apply the composition at the rate of 2-10 part of chlorite per part by weight of sulfide, with sufficient Mg(OH)₂ to achieve a pH of at least 7.5.

Sludge Dewatering: Chlorite reacts very rapidly with odor causing sulfidic compounds. For applications such as sludge dewatering, sufficient chlorite should be fed to consume the relatively high levels of sulfide which are present in such applications. The Mg(OH)₂ also buffers the pH upward into a range where the volatile form of sulfide is converted to the soluble form, thus providing some benefit in terms of odor control. In addition, the floc formed in the presence of the blend is predicted to be more stable and more easily dewatered than in the presence of either component alone. Finally, the presence of Mg(OH)2 has been found to inhibit corrosive properties of chlorite when the Mg(OH)2/chlorite ratio is around 3:1 on a weight: weight basis. A study of the corrosive properties of Mg(OH)2/chlorite at varying ratios, was compared to the corrosive properties of straight chlorite, and chlorite/nitrate mixtures.

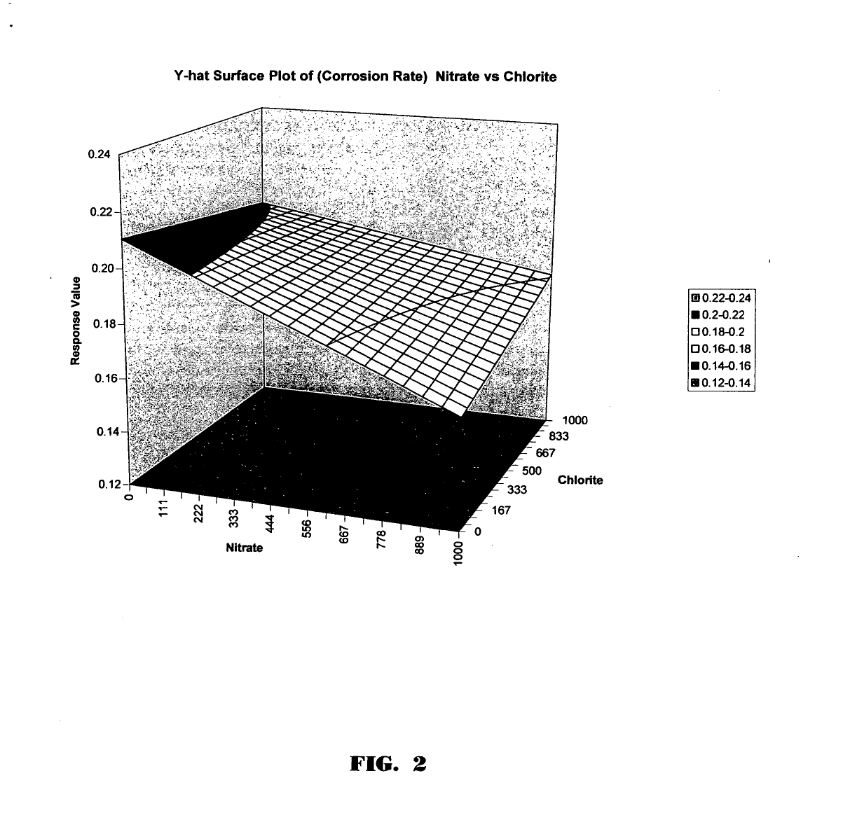

Corrosion Experiment FIG. 2: A Design of Experiments (DOE) methodology, a standard methodology of experimentation used to obtain the maximum information from the minimum number of experiments, was employed to investigate the corrosivity of a 22% chlorite-10% nitrate blend against stainless steel 316L. A central composite design was used. In this experiment, chlorite was varied from 0-1000 mg/L and nitrate was varied from 0-1000 mg/L.

The experimental conditions were determined by the DOE software, DOE PRO-XL, Air Academy Associates, corrosion rates obtained from weight loss of coupons. The data was then entered and the program generated the contour surface plot from the best fit to the experimental data.

The data indicate that in the absence of chlorite, the corrosion rate is reduced linearly with increasing nitrate concentration. With increase in chlorite concentration, the corrosion increases. There does appear to be a very slight improvement in corrosive effects of chlorite toward SS 316.

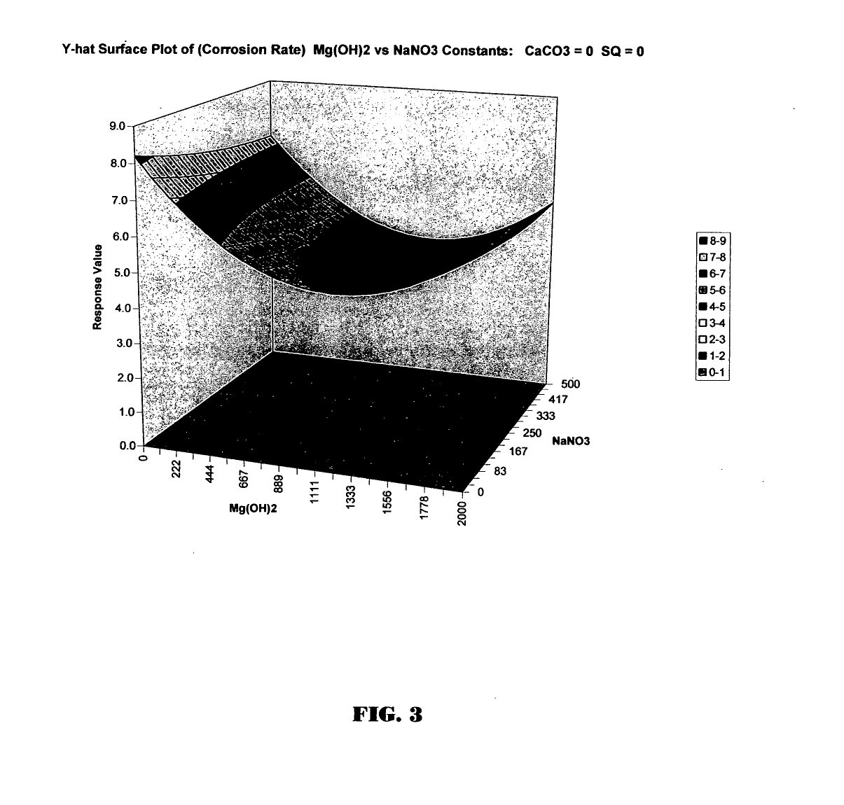

Corrosion Experiment FIG. 3: In this experiment, the impact of several chemicals, including Mg(OH)₂, NaNO3, CaCO3, and a polyphosphate based corrosion inhibitor denoted SQ toward the corrosiveness of 500 mg/L of sodium chlorite on carbon steel was measured. Again, a DOE approach was taken. A Full Factorial Design was chosen, with Mg(OH)₂ varying from 0-2000 mg/L, NaNO3 varying from 0-500 mg/L, CaCO3 varying from 0-2000 mg/L and SQ varying from 0-10 mg/L. The DOE software was used to establish the experimental parameters, and corrosion results were obtained by measuring weight loss of coupons.

A number of things can be identified from this information. First, the impact NaNO3 has on the corrosive effects of chlorite on the carbon steel corrosion rate is shown in the second plot.

In this plot, chlorite is 500 mg/L, and SQ (Sea Quest™, a mixture of 77% poly-phosphate) and CaCO3 are both held to 0. This plot shows that as the Mg(OH)₂ is increased, a minimum is reached at about 1100-1200 mg/L. On the other hand, when Mg(OH)2 is held to zero, as NaNO3 increases from 0 to 500 mg/L, there is almost no reduction in corrosion effects of chlorite. As CaCO3 (effects not shown) and NaNO3 showed very little improvement in corrosion rate, they were ignored in subsequent experiments.

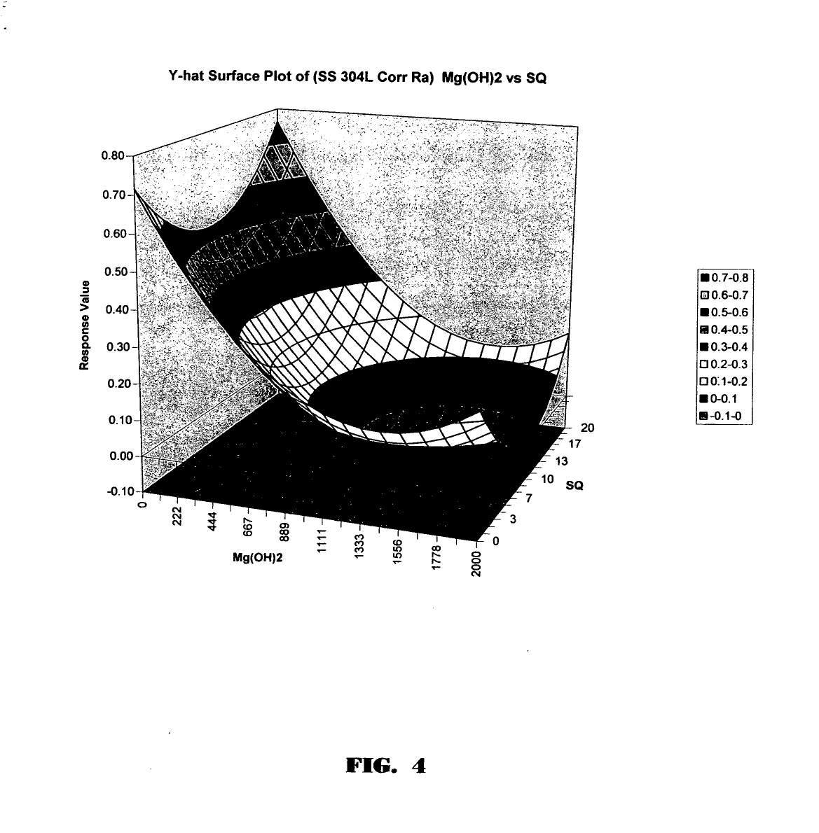

Corrosion Experiment FIG. 4: In this experiment, DOE was again used to measure the corrosive inhibiting effects of Mg(OH)₂ (0-2000 mg/L) and SQ (0-20 mg/L) toward 304L Stainless exposed to 500 mg/L NaClO2. The protocol was as described previously. The results are shown.

It is clear from the results of Experiment 2 and 3 that Mg(OH)2 has a substantial corrosion inhibiting properties on the corrosive effects of NaClO2, the corrosion rate being reduced by almost an order of magnitude when Mg(OH)2/chlorite ratio is around 2.5-3.5:1. Also, the polyphosphate product, SQ, shows even greater improvement in the corrosion rate, effectively stopping corrosion altogether with SQ at 10 mg/L and Mg(OH)2 at 1300-1500 mg/L.

The preferred embodiment of a composition for sludge dewatering would include a 25-45 wt % Mg(OH)2/6-25 wt % NaClO2 blend. The preferred composition would vary depending upon sludge pH, concentration of monovalent cations, and concentration of odor causing sulfidic compounds. The application rate would be to apply the composition at the rate of 2-10 part of chlorite per part by weight of sulfide, with sufficient Mg(OH)2 to achieve a pH of at least 7.5.

Unexpected benefits are predicted to arise also from application of this composition. Application of chlorite has been found to enhance dewaterability of produced sludge in some applications. In addition, application of Mg(OH)2 alone has also been found to promote the dewaterability of sludge, although the mechanisms by which these two chemicals act are thought to be different. There is an expected synergy when both of these chemicals are applied simultaneously in that the dewaterability of sludge is enhanced over that which would be seen by application of each chemical separately.

We predict an improvement in the sludge dewaterability from 5-50% or more, as measured by Capillary Suction Timer or Time-to-Filter tests as described in ‘Standard Methods,’ over the application of each component individually.

Dewatered Sludge: The treatment of the sludge during dewatering application by the method and composition described above will generally be sufficient to accomplish the immediate goal of oxidation of sulfidic compound and odor control by such method. In some cases, the sludge produced from the dewatering application is stored for later removal or land fill application. Odors have been found to emanate from such dewatered sludge, and so supplemental chemicals may be utilized during the dewatering application to extend the time of odor control. In addition, there may be a requirement for pathogen destruction of the sludge prior to landfill.

The preferred embodiment for odor control during sludge dewatering applications would include a 25-45 wt % Mg(OH)₂, 6-25 wt % NaClO2, 0.1-10 wt % THPS, and 0.1-40 wt % NaNO3. The preferred composition would vary depending upon sludge pH, concentration of monovalent cations, and concentration of odor causing sulfidic compounds. The application rate would be to apply the composition at the rate of 2-10 part of chlorite per part by weight of sulfide, sufficient Mg(OH)₂ to achieve a pH of at least 7.5, sufficient THPS to accomplish at least a 1 log reduction in pathogenic bacteria, and sufficient NaNO3 to retard the growth of sulfide-producing bacteria so that odors attributable to sulfidic compounds are not obvious for at least 24 hours.

An unexpected benefit of this method and composition is that long term odor of dewatered sludge, is predicted to be controlled much better by the composition than by each component of the composition when applied separately.

What is claimed is:

1. A composition useful for reducing sulfidic odors comprising effective amounts of a sulfide consuming chemical and a pH elevating and buffering compound.

2. The composition of claim 1 wherein the sulfide consuming chemical is a chlorite salt and the pH elevating and buffering compound is selected from the group comprising metal or alkali metal carbonate, metal or alkali metal peroxide, metal or alkali metal oxide or of metal or alkali metal hydroxide which either release hydroxide into the water or react with water for form hydroxide.

3. The composition of claim 2 wherein the chlorite salt is sodium chlorite present in an amount of 0.01-65%, and the alkali metal oxide, carbonate, peroxide, or hydroxide is magnesium hydroxide and is present in an amount of 35-99.99%

4. A composition useful for reducing sulfidic odors comprising effective amounts of a sulfide consuming chemical, a pH elevating and buffering compound, and an organic biocide known to be effective against bacteria that produce sulfide.

5. The composition of claim 4 wherein the sulfide consuming chemical is a chlorite salt and the pH elevating and buffering compound is selected from the group comprising metal or alkali metal carbonate, metal or alkali metal peroxide, metal or alkali metal oxide or of metal or alkali metal hydroxide which either release hydroxide into the water or react with water for form hydroxide, and the organic biocide is selected from the group glutaraldehyde or tetrakis (hydroxymethyl) phosphonium sulphate (THPS).

6. The composition of claim 4 wherein the chlorite salt is sodium chlorite present in an amount of 0.01-65% by weight, the alkali metal oxide, carbonate, peroxide, or hydroxide is magnesium hydroxide and is present in an amount of 35-99.99% by weight, and the organic biocide is THPS present in an amount of 0.01-10% by weight.

7. A composition useful for reducing sulfidic odors comprising effective amounts of a sulfide consuming chemical, a pH elevating and buffering compound, an organic biocide known to be effective against bacteria that produce sulfide, and a compound which acts as a terminal electron acceptor in bacterial respiration.

8. The composition of claim 7 wherein the sulfide consuming chemical is a chlorite salt and the pH elevating and buffering compound is selected from the group comprising metal or alkali metal carbonate, metal or alkali metal peroxide, metal or alkali metal oxide or of metal or alkali metal hydroxide which either release hydroxide into the water or react with water for form hydroxide, the organic biocide is selected from the group glutaraldehyde or tetrakis (hydroxymethyl) phosphonium sulphate (THPS), and the terminal electron acceptor is a nitrate salt.

9. The composition of claim 7 wherein the chlorite salt is sodium chlorite present in an amount of 0.01-65% by weight, the alkali metal oxide, carbonate, peroxide, or hydroxide is magnesium hydroxide and is present in an amount of 35-99.99% by weight, the organic biocide is THPS present in an amount of 0.01-10% by weight, and the nitrate salt is sodium nitrate present in an amount of 0.01-40% by weight.

10. A process for removing dissolved hydrogen sulfide and odoriferous reduced sulfur compounds found in waste systems and preventing their biogenic formation, comprising the step of adding to the waste system an aqueous composition comprising a combination of a sulfide consuming chemical, an alkali metal oxide or hydroxide in a wt ratio comprising 2-10 parts sulfide consuming chemical, and sufficient alkali metal oxide or hydroxide to achieve a minimum pH of 7.5.

11. A process according to claim 10 where the sulfide consuming chemical is selected from the group comprising alkali metal salts of hypochlorite, chlorite, nitrite, peroxide, percarbonate, perborate, or ferrous or ferric iron salts, peroxymonosulfuric acid, chlorine, hydrogen peroxide and chlorine dioxide.

12. A process according to claim 11 where the sulfide consuming chemical is an alkali metal chlorite.

13. A process according to claim 12 where the alkali metal chlorite is selected from the group comprising sodium chlorite, calcium chlorite, or potassium chlorite.

14. A process according to claim 13 where the alkali metal chlorite is sodium chlorite.

15. A process according to claim 10 where the alkali metal oxide or hydroxide is selected from the group comprising calcium oxide, calcium hydroxide, magnesium oxide, and magnesium hydroxide.

16. A process according to claim 11 wherein an aluminum salt is incorporated into the blend and is fed so that the aluminum has the benefit of reducing phosphate in the downstream wastewater plant.

17. A process according to claim 12 wherein the composition is added to provide sulfide consuming chemical in the ratio of 2-10 parts sulfide-consuming chemical per part sulfide to accomplish removal of sulfide.

18. A process according to claim 13 wherein the composition is added to provide sufficient alkali metal oxide or hydroxide to achieve a minimum wastewater pH of 7.5.

19. A process for removing dissolved odoriferous sulfidic compounds (sulfidic compounds defined in the body of text to include all odoriferous reduced sulfur compounds found in wastewater including dissolved hydrogen sulfide), in waste systems comprising the step of:
Adding to the waste either a dry or an aqueous composition comprising a combination of a sulfide consuming chemical and an alkali metal oxide, carbonate, peroxide or hydroxide for pH elevation in such a manner that the applied dosage ratio comprises 1-10 parts by weight of sulfide-consuming chemical per part by weight of sulfide and sufficient pH-elevating alkali metal oxide or hydroxide to achieve a minimum pH of 7.5, an effective amount of organic biocide, and an effective amount of nitrate salt.

20. A process according to claim 19 where the sulfide consuming chemical is selected from the group comprising alkali metal salts of hypochlorite, chlorite, nitrite, peroxide, percarbonate, perborate, or ferrous or ferric iron salts, peroxymonosulfuric acid, chlorine, hydrogen peroxide and chlorine dioxide.

21. A process according to claim 20 where the sulfide consuming chemical is an alkali metal chlorite.

22. A process according to claim 21 where the alkali metal chlorite is selected from the group comprising sodium chlorite, calcium chlorite, or potassium chlorite.

23. A process according to claim 22 where the alkali metal chlorite is sodium chlorite.

24. A process according to claim 19 where the alkali metal oxide, carbonate, peroxide or hydroxide is selected from the group comprising calcium oxide, calcium hydroxide, calcium peroxide, calcium carbonate, magnesium oxide, magnesium carbonate, magnesium peroxide, and magnesium hydroxide.

25. A process according to claim 19 wherein an aluminum salt is incorporated into the blend and is fed so that the aluminum has the benefit of both consuming sulfide and reducing phosphate in the downstream wastewater plant.

26. A process according to claim 19, where the composition is in the form of an aqueous solution.

27. A process according to claim 19 wherein the composition is added to provide sulfide-consuming chemical in the weight ratio of 1-10 parts by weight of sulfide-consuming chemical per part by weight of sulfide to accomplish removal of sulfide.

28. A process according to claim 19 wherein the composition is added to provide sufficient pH elevating and buffering compound to achieve a minimum pH of 7.5.

29. A process according to claim 19 where the composition is in the form of a dry solid.

30. A process according to claim 19 wherein the composition is added to provide sulfide consuming chemical in the weight ratio of 1-10 parts by weight of sulfide-consuming chemical per part by weight of sulfide to accomplish removal of sulfide.

31. A process according to claim 19 wherein the composition is added to provide sufficient pH elevating and buffering compound to achieve a minimum pH of 7.5 to prevent biogenic generation of sulfide.

32. A process for enhancing the dewaterability of wastewater sludge comprising the step of:
Adding to the waste either a dry or an aqueous composition comprising a combination of a sulfide consuming chemical and an alkali metal oxide, carbonate, peroxide or hydroxide for pH elevation in such a manner that the applied dosage ratio comprises 1-10 parts by weight of sulfide-consuming chemical per part by weight of sulfide and sufficient pH-elevating alkali metal oxide or hydroxide to achieve a minimum pH of 7.5.

33. A process according to claim 32, wherein the dewaterability is improved by the application of the composition by 5 to 50% or more over each component of the composition when applied individually, as measured by either Capillary Suction Timer or Time-to-Filter tests.

34. A process for enhancing the long term odor control of dewatered wastewater sludge comprising the step of:
Adding to the waste either a dry or an aqueous composition comprising a combination of a sulfide consuming chemical and an alkali metal oxide, carbonate, peroxide or hydroxide for pH elevation in such a manner that the applied dosage ratio comprises 1-10 parts by weight of sulfide-consuming chemical per part by weight of sulfide and sufficient pH-elevating alkali metal oxide or hydroxide to achieve a minimum pH of 7.5.

35. A process according to claim 34, wherein the long term odor is H2S, mercaptan, ammonia or amines.
